(19) United States
(12) Patent Application Publication
(10) Pub. No.: US 2014/0047447 A1
(43) Pub. Date: Feb. 13, 2014

(54) WORK SCHEDULING METHOD AND SYSTEM IMPLEMENTED VIA CLOUD PLATFORM

(71) Applicant: QUANTA COMPUTER INC., Kuei Shan Hsiang (TW)

(72) Inventors: Tien-Chin Fang, Kuei Shan Hsiang (TW); Chen-Chung Lee, Kuei Shan Hsiang (TW); Chun-Hung Chen, Kuei Shan Hsiang (TW); Meng-Yu Li, Kuei Shan Hsiang (TW); Ta-Feng Teng, Kuei Shan Hsiang (TW); Chia-Chen Chiang, Kuei Shan Hsiang (TW); Yu-Jen Lin, Kuei Shan Hsiang (TW)

(73) Assignee: Quanta Computer Inc., Kuei Shan Hsiang (TW)

(21) Appl. No.: 13/872,344

(22) Filed: Apr. 29, 2013

(30) Foreign Application Priority Data
Aug. 9, 2012 (TW) 101128718

(51) Int. Cl. G06F 9/46; G06F 9/445

(52) U.S. Cl. CPC G06F 9/46; G06F 9/44521
USPC 718/102

(57) ABSTRACT

A work scheduling method implemented via a cloud platform is provided. The work scheduling method is used in a cloud platform work schedule system. The method includes: arranging, by a developing interface of a developing module, a work schedule; generating, by the developing module, a dynamic linking library (DLL) which corresponds to the work schedule and uploading the dynamic linking library to the cloud platform through the internet; transferring, by a disposing module, the dynamic linking library to a Application service; computing, by a scheduling module, a scheduling time according to the work schedule; and executing, by an executing module, the application service according to the scheduling time.

### CROSS REFERENCE TO RELATED APPLICATIONS

The present application is based on, and claims priority from, Taiwan (International) Application Serial Number 101128718, filed on Aug. 9, 2012, the invention of which is hereby incorporated by reference herein in its entirety.

### TECHNICAL FIELD

The present invention relates to a work scheduling method and a work scheduling system, and in particular, relates to a work scheduling method and a work scheduling system implemented via a cloud platform.

### BACKGROUND

Work scheduling services are often auxiliary services of an application system, and perform specific tasks regularly to support the operation of the application system. Most tasks are works, such as data statistical, data backup, or other specific works the system needs to perform. Data statistical often requires the integration of a large amount of information and relevant data. The type of the work schedule is usually used to compile the statistics for data, and it may take a lot of time for the system. To avoid the application system taking a lot of time to process the calculations when a front-end user operates the system, a program developer often uses the work schedule for the calculations to improve the computing performance of the front-end user program and enhance the quality of the service of the application system. Data backup is also often an essential back-end service of the application system. However, a lot of time is also needed to backup a large amount of data. Different application systems may execute works at different times regularly, for example, to send an email, or to check data, and so on. These services can be usually achieved through the work scheduling service.

For conventional work scheduling services, developers need to transfer a computer-implemented process to an executable file. Then, the work scheduling service with a server operating system may arrange the work schedule, or a scheduling system developed by the program developer independently may execute the work schedule. The program developer has to know the database connection information and the server data of the application systems clearly to write the program of the executable file for creating the work schedule. In a cloud environment, however, when a user wants to develop the application system service in the cloud platform, the cloud platform often only provides a uniform resource locator (URL) for the user to enter, and does not provide the server of the application system for the user to arrange the work schedule. In addition, the database connection information is hidden in the cloud platform. Thus, the program developer does not know the database connection information. Therefore, it is a challenge to execute correct connections for different work schedules to achieve system accuracy.

### SUMMARY

A detailed description is given in the following embodiments with reference to the accompanying drawings.

A work scheduling method and system implemented via a cloud platform are provided.

In one exemplary embodiment, the invention is directed to a work scheduling method implemented via a cloud platform, used in a work scheduling system, comprising: creating, by a developing interface of a developing module, a work schedule; generating, by the developing module, a dynamic linking library (DLL) which corresponds to the work schedule and uploading the dynamic linking library to the cloud platform through the internet; transferring, by a disposing module, the dynamic linking library to an application service; computing, by a scheduling module, a scheduling time according to the work schedule; and executing, by an executing module, the application service according to the scheduling time.

In one exemplary embodiment, the invention is directed to a work scheduling system implemented via a cloud platform. The work scheduling system comprises a client device and a cloud platform, wherein the client device is coupled to the cloud platform. The client device comprises a developing module, and the developing module is configured to provide a developing interface for a user to create a work schedule and generate a dynamic linking library (DLL) which corresponds to the work schedule. The cloud platform is configured to receive the dynamic linking library uploaded by the client device through the internet. The cloud platform comprises a disposing module, a scheduling module and an executing module. The disposing module is configured to transfer the dynamic linking library to an application service. The scheduling module is configured to compute a scheduling time according to the work schedule created by the user. The executing module is configured to execute the application service according to the scheduling time.

### DRAWINGS The present invention can be more fully understood by reading the subsequent detailed description and examples with references made to the accompanying drawings, wherein:

FIG. 1 is a schematic diagram of a work scheduling system implemented via a cloud platform according to an embodiment of the present invention.

FIG. 2 is a flow diagram illustrating a client device creating a work schedule according to an embodiment of the present invention.

FIG. 3 is a flow diagram illustrating the operation process of the cloud platform according to an embodiment of the present invention.

FIG. 4 is a flow diagram illustrating the operation process of the work scheduling system implemented via the cloud platform according to an embodiment of the present invention.

### DETAILED DESCRIPTION

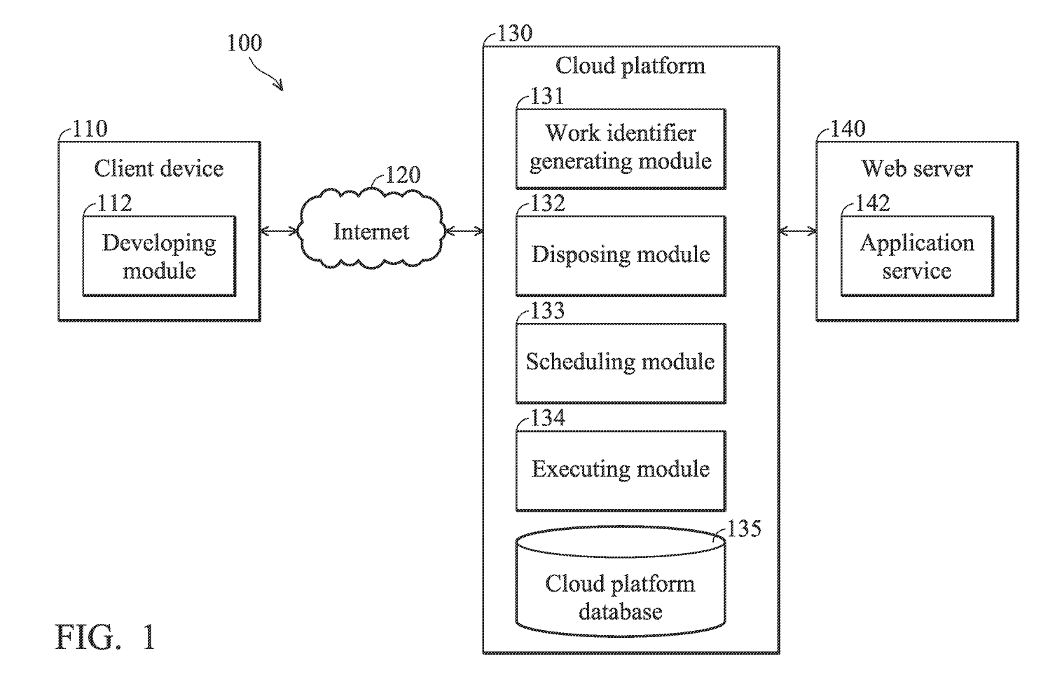

Several exemplary embodiments of the application are described with reference to FIGS. 1 through 4, which generally relate to a work scheduling method and system implemented via a cloud platform. It is to be understood that the following invention provides various different embodiments as examples for implementing different features of the application. Specific examples of components and arrangements are described in the following to simplify the present invention. These are, of course, merely examples and are not intended to be limiting. In addition, the present invention may repeat reference numerals and/or letters in the various examples. This repetition is for the purpose of simplicity and clarity and does not in itself dictate a relationship between the various described embodiments and/or configurations.

Embodiments described below illustrate a work scheduling method and system implemented via a cloud platform of the present invention.

FIG. 1 is a schematic diagram of a work scheduling system 100 implemented via a cloud platform according to an embodiment of the present invention. As show in FIG. 1, the work scheduling system 100 implemented via a cloud platform includes a client device 110, a cloud platform 130 and a Web server 140. The client device 110 and the cloud platform 130 communicate with each other through the internet 120. The Web server 140 links to the cloud platform 130 through a communications network, and stores application service 142. The application service 142 includes software or an operating system service which is provided for the cloud platform 130 to use, for example, a windows communication foundation (WCF) service.

The client device 110 includes a developing module 112. The developing module 112 is configured to provide a developing interface to a user to create a work schedule, and generate a dynamic linking library (DLL) which corresponds to the work schedule. After generating the dynamic linking library corresponding to the work schedule, the developing module 112 uploads the dynamic linking library to the cloud platform 130 through the internet 120. In another embodiment, the developing module 112 can compress the dynamic linking library into a compressed file, and upload the compressed file to the cloud platform 130 through the internet 120. It is worth noting that when the developing module 112 uploads the compressed file, the developing module 112 further generates an assembly name and a type name corresponding to the dynamic linking library, wherein the cloud platform 130 can use the assembly name and the type name to execute the dynamic linking library.

It is worth noting that when uploading the file, the developing module 112 must specify which application service 142 in the Web server 140 that the work schedule belongs to. Therefore, the cloud platform 130 can ensure that database connection information of the application service is correct.

The cloud platform 130 includes a work identifier generating module 131, a disposing module 132, a scheduling module 133, an executing module 134 and a cloud platform database 135. When the cloud platform 130 receives the dynamic linking library uploaded by the client device 110 through the Internet 120, the work identifier generating module 131 generates a work number identifier which corresponds to the dynamic linking library. The cloud platform 130 stores the dynamic linking library, the assembly name, the type name and the work number identifier into the cloud platform database 135.

Then, the disposing module 132 integrates the dynamic linking library stored in the cloud platform database 135 into an application service sample, and generates an application service by using the work number identifier. In another embodiment, the application service sample is an executable application. The scheduling module 133 allows the user to maintain a time setting of the work schedule. The user can create multiple schedules for different works, different execution times and different requirements. The scheduling module 133 computes a scheduling time of executing works for each time according to the multiple schedules. Finally, the executing module 134 executes the corresponding application services according to the scheduling time.

Specifically, but not limited to such examples, when the user compresses the dynamic linking library into a compressed file and uploads the compressed file to the cloud platform 130, the disposing module 132 of the cloud platform 130 decompresses the compressed file automatically, and copies the dynamic linking library to a document in the application service sample. Then, the disposing module 132 disposes the application service sample in the Web server 140 through the internet to transfer the application service sample to the application service. In the process of disposing the application service sample, the disposing module 132 specifies a specific identity used to execute the application service in advance, wherein the specific identity is only one active directory (AD) identity in a cloud environment. The cloud platform 130 stipulates that the active directory can only access the related resources of the application service. It is worth noting that the work schedule is not an executable file, but an application service in the cloud environment. The disposing module 132 names the application service according to the work number identifier and generates a schedule work service uniform resource locator (URL), wherein the schedule work service URL is the only one specific URL corresponding to the work schedule. When the executing module 134 executes the application service, the Web server 140 may use the schedule work service URL to start the application service in an execution environment.

Then, the application service is performed and operated in the execution environment. Therefore, sandbox security permissions when the application service is operated are not violated. The concept of the sandbox is from a security model called JDK 1.2, and the sandbox security limits resources of the entire system to only the dependable program code that was originally installed by the user. If the program code is not dependable, the program code is executed in the sandbox. In addition, the program code executed in the sandbox only has partial access and full access of the resources of the entire system. In the way, a program code which can destroy the system security will not threaten the system.

In other embodiments, the executing module 134 can use an agent system to operate the work schedule. The agent detects the work schedule stored in the cloud platform database 135 according to a predetermined time, and informs the Web server 140 to open the work schedule service URL to execute the corresponding application service according to the scheduling time computed by the scheduling module. The schedule work service URL is an application service URL generated by the disposing module 132. When the executing module 134 starts the application service, the specific identity specified by the disposing module 132 is used to operate the application service and establish an instance to execute the work schedule according to the assembly name and the type name generated by the developing module 112.

It is worth noting that when the database connection information of the application service exists in the cloud platform database 135, the scheduling module 133 may obtain the database connection information of the application service automatically. The database connection information of the application service is established when the user applies to use a product and database. Therefore, the work scheduling system 100 of the cloud platform is ensured of being connected to the correct dynamic linking library, and will not violate the sandbox security permissions when the work scheduling system 100 of the cloud platform is in operation.

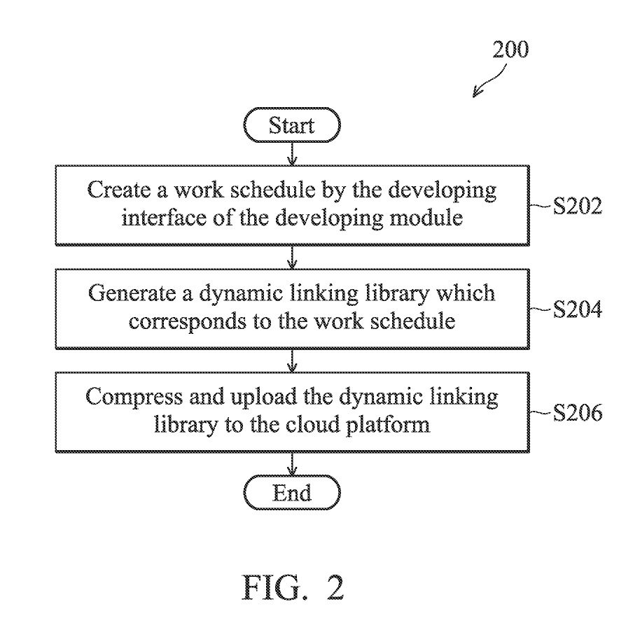

FIG. 2 is a flow diagram 200 illustrating a client device creating a work schedule according to an embodiment of the present invention. As shown in FIG. 2, in step S202, the user creates a work schedule by the developing interface of the developing module. Then, in step S204, the developing module generates a dynamic linking library (DLL) which corresponds to the work schedule. In step S206, the developing module compresses and uploads the dynamic linking library to the cloud platform.

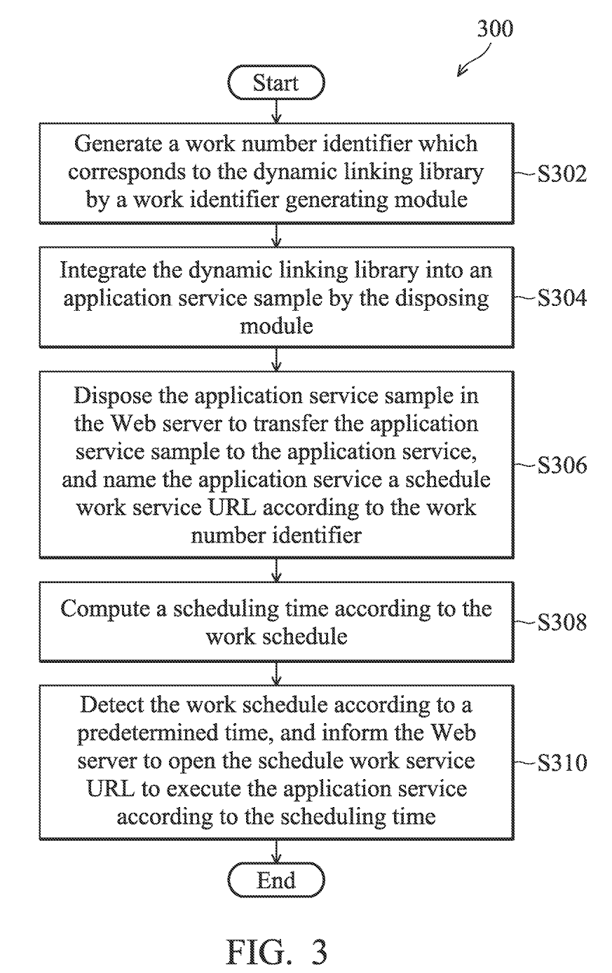

FIG. 3 is a flow diagram 300 illustrating the operation process of the cloud platform according to an embodiment of the present invention. After receiving the compressed dynamic linking library, in step S302, the cloud platform generates a work number identifier which corresponds to the dynamic linking library by a work identifier generating module. In step S304, the cloud platform decompresses the compressed dynamic linking library, integrates the dynamic linking library into an application service sample by the disposing module. Then, in step S306, the disposing module disposes the application service sample in the Web server to transfer the application service sample to the application service, and names the application service a schedule work service URL according to the work number identifier. In step S308, the scheduling module computes a scheduling time according to the work schedule. In step S310, the executing module detects the work schedule according to a predetermined time, and informs the Web server to open the schedule work service URL to execute the application service according to the scheduling time.

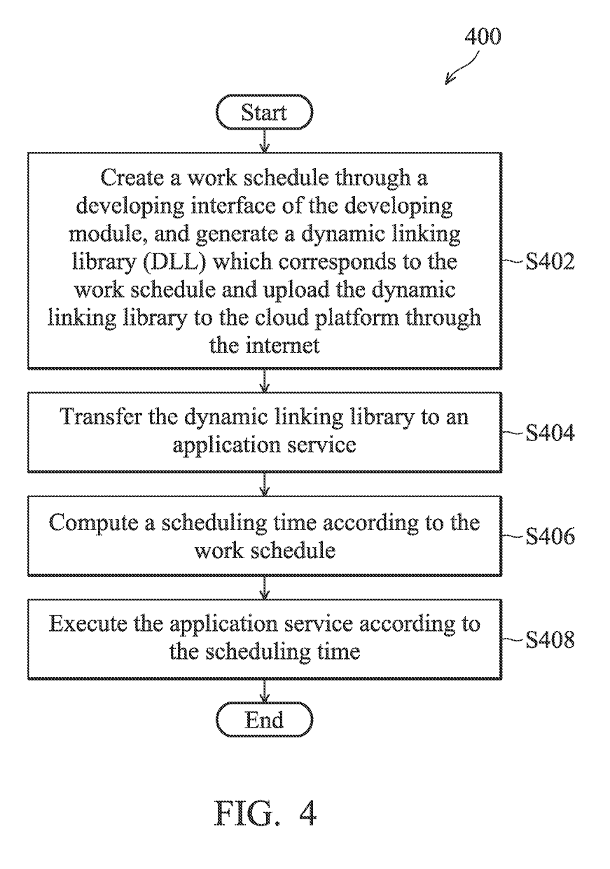

FIG. 4 is a flow diagram 400 illustrating the operation process of the work scheduling system implemented via the cloud platform according to an embodiment of the present invention. In step S402, a work schedule is created by the user through a developing interface of the developing module, and the developing module generates a dynamic linking library (DLL) which corresponds to the work schedule and uploads the dynamic linking library to the cloud platform through the internet. In step S404, the disposing module transfers the dynamic linking library to an application service. Then, in step S406, the scheduling module computes a scheduling time according to the work schedule. Finally, in step S408, the executing module executes the application service according to the scheduling time.

Therefore, program developers can develop and implement the work scheduling service easily by using the work scheduling method and the work scheduling system implemented via the cloud platform according to the invention. The user can establish the connection between the application service and the database in advance to store the database connection information in the cloud platform database. After the user creates the work schedule through the developing interface, the cloud platform transfers the dynamic linking library to the application service through the modules of the work scheduling system and uses the agent system to execute the application service for achieving the work scheduling service.

In addition, the most important advantage of the present invention is that the execution process of the work scheduling service does not violate the sandbox security permissions. After the dynamic linking library is uploaded to the cloud platform, the cloud platform transfers the dynamic linking library to an application service. An active directory may be assigned to the application service, and the cloud platform stipulates that the active directory may only access the related resources of the application service. When some problems arise in the executable file developed by the user, the executable file only affects the individual work schedule and does not affect the operation of other systems.

The work scheduling methods implemented via the cloud platform may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A work scheduling method implemented via a cloud platform, used in a work scheduling system, comprising:
creating, by a developing interface of a developing module, a work schedule;
generating, by the developing module, a dynamic linking library (DLL) which corresponds to the work schedule and uploading the dynamic linking library to the cloud platform through the internet;
transferring, by a disposing module, the dynamic linking library to an application service;
computing, by a scheduling module, a scheduling time according to the work schedule; and
executing, by an executing module, the application service according to the scheduling time.

2. The work scheduling method implemented via a cloud platform as claimed in claim 1, further comprising:
generating, by a work identifier generating module, a work number identifier which corresponds to the dynamic linking library after the cloud platform receives the dynamic linking library; and
storing, by a cloud platform database, the dynamic linking library and the work number identifier.

3. The work scheduling method implemented via a cloud platform as claimed in claim 1, further comprising:
storing, by a Web server, the application service.

4. The work scheduling method implemented via a cloud platform as claimed in claim 3, wherein the step of transferring, by a disposing module, the dynamic linking library to an application service, further comprises:
integrating the dynamic linking library into an application service sample;
disposing the application service sample in the Web server to transfer the application service sample to the application service; and
naming the application service a schedule work service uniform resource locator (URL) according to the work number identifier.

5. The work scheduling method implemented via a cloud platform as claimed in claim 4, further comprising:
detecting, by the executing module, the work schedule according to a predetermined time, and informing the Web server to open the schedule work service URL to execute the application service according to the scheduling time.

6. The work scheduling method implemented via a cloud platform as claimed in claim 1, wherein the developing module further generates an assembly name and a type name corresponding to the dynamic linking library.

7. A work scheduling system implemented via a cloud platform, comprising:
a client device, comprising:
a developing module, configured to provide a developing interface for a user to create a work schedule, and generate a dynamic linking library (DLL) which corresponds to the work schedule; and
a cloud platform, coupled to the client device and configured to receive the dynamic linking library uploaded by the client device through the internet, comprising:
a disposing module, configured to transfer the dynamic linking library to an application service;
a scheduling module, configured to compute a scheduling time according to the work schedule created by the user; and
an executing module, configured to execute the application service

8. The work scheduling system implemented via a cloud platform as claimed in claim 7, wherein the cloud platform further comprises:
a work identifier generating module, configured to generate a work number identifier which corresponds to the dynamic linking library after the cloud platform receives the dynamic linking library uploaded by the client device; and
a cloud platform database, configured to store the dynamic linking library and the work number identifier therein.

9. The work scheduling system implemented via a cloud platform as claimed in claim 8, further comprising:
a Web server, coupled to the cloud platform and configured to the application service.

10. The work scheduling system implemented via a cloud platform as claimed in claim 9, wherein the disposing module integrates the dynamic linking library into an application service sample, disposes the application service sample in the Web server to transfer the application service sample to the application service, and names the application service according to the work number identifier and generates a schedule work service uniform resource locator (URL).

11. The work scheduling system implemented via a cloud platform as claimed in claim 10, wherein the executing module detects the work schedule according to a predetermined time, and informs the Web server to open the schedule work service URL to execute the application service according to the scheduling time.

12. The work scheduling system implemented via a cloud platform as claimed in claim 7, wherein the developing module further generates an assembly name and a type name corresponding to the dynamic linking library.
